(19) United States
(12) Patent Application Publication
(10) Pub. No.: US 2024/0087822 A1
(43) Pub. Date: Mar. 14, 2024

(54) Vacuum Interrupter

(71) Applicant: ABB Schweiz AG, Baden (CH)

(72) Inventors: Dietmar Gentsch, Ratingen (DE); Christian Reuber, Willich (DE)

(73) Assignee: ABB Schweiz AG, Baden (CH)

(21) Appl. No.: 18/516,202

(22) Filed: Nov. 21, 2023

Related U.S. Application Data
(63) Continuation of application No. PCT/EP2022/062891, filed on May 12, 2022.

(30) Foreign Application Priority Data
May 21, 2021 (EP) 21175316.5

(51) Int. Cl. H01H 1/02; H01H 33/664

(52) U.S. Cl. CPC H01H 1/0206; H01H 33/6643

(57) ABSTRACT

A vacuum interrupter includes a first contact carrier; a first contact piece; a second contact carrier; and a second contact piece; wherein the first contact piece is connected to the first contact carrier; wherein the second contact piece is connected to the second contact carrier; wherein a shape of the first contact piece is different to a shape of the second contact piece and/or a material of the first contact piece is different to a material of the second contact piece; wherein in a deactivated state the vacuum interrupter is configured to hold the first contact piece spaced from the second contact piece; and wherein in an activated state the vacuum interrupter is configured to bring the first contact piece and the second contact piece into contact with one another.

### CROSS-REFERENCE TO RELATED APPLICATIONS

The instant application claims priority to International Patent Application No. PCT/EP2022/062891, filed May 12, 2022, and to European Patent Application No. 21175316.5, filed May 21, 2021, each of which is incorporated herein in its entirety by reference.

### FIELD OF THE DISCLOSURE

The present disclosure relates a vacuum interrupter and to a method of manufacturing a vacuum interrupter.

### BACKGROUND OF THE INVENTION

Vacuum interrupters are required to have contacts that can operate with a high short circuit switching performance and resist becoming welded together. These requirements are not simple to achieve.

### BRIEF SUMMARY OF THE INVENTION

There is a need to improve known vacuum interrupters. The present disclosure describes an improved vacuum interrupter technology.

In a first aspect, there is provided a vacuum interrupter, comprising: a first contact carrier; a first contact piece; a second contact carrier; and a second contact piece. In one embodiment, the first contact piece is connected to the first contact carrier. The second contact piece is connected to the second contact carrier. A shape of the first contact piece is different to a shape of the second contact piece and/or a material of the first contact piece is different to a material of the second contact piece. In a deactivated state the vacuum interrupter is configured to hold the first contact piece spaced from the second contact piece. In an activated state the vacuum interrupter is configured to bring the first contact piece and the second contact piece into contact with one another.

### BRIEF DESCRIPTION OF THE SEVERAL VIEWS OF THE DRAWING(S)

FIG. 1 shows an example of a vacuum interrupter in accordance with the disclosure.

FIG. 2 shows an additional example of a vacuum interrupter in accordance with the disclosure.

FIG. 3 shows an additional example of a vacuum interrupter in accordance with the disclosure.

### DETAILED DESCRIPTION OF THE INVENTION

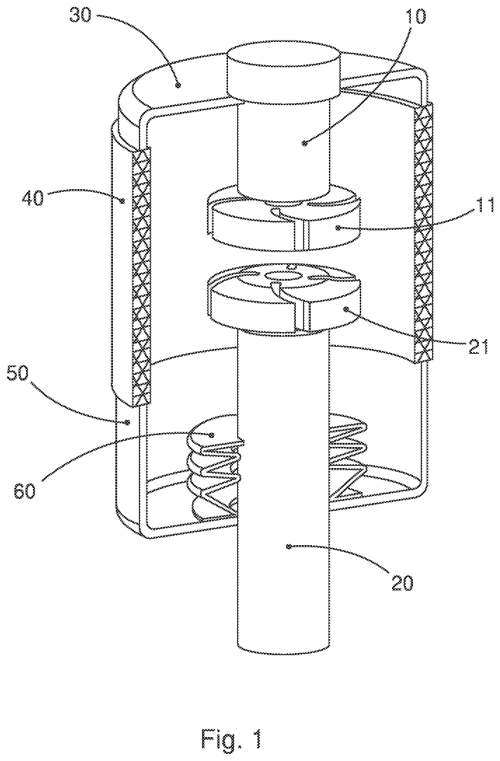

FIGS. 1-3 relate to a vacuum interrupter and to a method of manufacturing a vacuum interrupter.

In an example, a vacuum interrupter 1 comprises a first contact carrier 10, a first contact piece 11, a second contact carrier 20, and a second contact piece 21. The first contact piece is connected to the first contact carrier. The second contact piece is connected to the second contact carrier. A shape of the first contact piece is different to a shape of the second contact piece. Alternatively, or additionally a material of the first contact piece is different to a material of the second contact piece. In a deactivated state the vacuum interrupter is configured to hold the first contact piece spaced from the second contact piece. In an activated state the vacuum interrupter is configured to bring the first contact piece and the second contact piece into contact with one another.

According to an example, the first contact carrier is a fixed contact carrier, and the second contact carrier is a movable contact carrier, and in the activated state the vacuum interrupter is configured to move the second contact carrier to bring the first contact piece and the second contact piece into contact with one another.

According to an example, the material of the first contact piece is a first alloy of CuCr and the material of the second contact piece is a second alloy of CuCr.

According to an example, the material of the first contact piece is CuCr10 and the material of the second contact piece is CuCr50.

According to an example, the material of the first contact piece is CuCr25 and the material of the second contact piece is CuCr35.

According to an example, the material of the first contact piece is a first alloy of WCAg and the material of the second contact piece is a second alloy of WCAg.

According to an example, the material of the first contact piece is WCAg40 and the material of the second contact piece is WCAg20.

According to an example, the material of the first contact piece is CuCr and the material of the second contact piece is CuCr with a content of 0.1% to 5% of at least one material comprising Fe, Al, Cr, V, Nb, Ta, Hf, Sn, Zr or Si.

According to an example, the at least one material comprises an oxide, nitride or boride of Fe, Al, Cr, V, Nb, Ta, Hf, Sn, Zr or Si.

According to an example, the material of the first contact piece is CuCr and the material of the second contact piece is WCu.

According to an example, the material of the first contact piece is CuCr and the material of the second contact piece is MoCu.

According to an example, the material of the first contact piece comprises one of W, CuCr, CuBi, WCu, MoCu, WCAg and the material of the second contact piece comprises one of W, CuCr, CuBi, WCu, MoCu, WCAg.

According to an example, a size of the first contact piece is different to a size of the second contact piece.

According to an example, a diameter of the first contact piece is less than a diameter of the second contact piece.

According to an example, the vacuum interrupter comprises an upper lid 30. The first contact carrier is fixedly connected to the upper lid. Prior to the first contact carrier being fixedly connected to the upper lid the upper lid comprises a hole with a diameter greater than a diameter of the first contact piece and greater than a diameter of at least a portion of the first contact carrier adjacent to the first contact piece.

In an example, a method of manufacturing a vacuum interrupter 1, comprises: connecting a first contact piece 11 to a first contact carrier 10; connecting a second contact piece 21 to a second contact carrier 20; wherein a shape of the first contact piece is different to a shape of the second contact piece and/or a material of the first contact piece is different to a material of the second contact piece; wherein in a deactivated state the vacuum interrupter is configured to hold the first contact piece spaced from the second contact piece; and wherein in an activated state the vacuum interrupter is configured to bring the first contact piece and the second contact piece into contact with one another.

In an example, the first contact carrier is a fixed contact carrier, and the second contact carrier is a movable contact carrier, and in the activated state the vacuum interrupter is configured to move the second contact carrier to bring the first contact piece and the second contact piece into contact with one another.

In an example, the material of the first contact piece is a first alloy of CuCr and the material of the second contact piece is a second alloy of CuCr.

In an example, the material of the first contact piece is CuCr10 and the material of the second contact piece is CuCr50; or wherein the material of the first contact piece is CuCr25 and the material of the second contact piece is CuCr35.

In an example, the material of the first contact piece is a first alloy of WCAg and the material of the second contact piece is a second alloy of WCAg.

In an example, the material of the first contact piece is WCAg40 and the material of the second contact piece is WCAg20.

In an example, the material of the first contact piece is CuCr and the material of the second contact piece is CuCr with a content of 0.1% to 5% of at least one material comprising Fe, Al, Cr, V, Nb, Ta, Hf, Sn, Zr or Si.

In an example, the at least one material comprises an oxide, nitride or boride of Fe, Al, Cr, V, Nb, Ta, Hf, Sn, Zr or Si.

In an example, the material of the first contact piece is CuCr and the material of the second contact piece is WCu or MoCu.

In an example, the material of the first contact piece comprises one of W, CuCr, CuBi, WCu, MoCu, WCAg and the material of the second contact piece comprises one of W, CuCr, CuBi, WCu, MoCu, WCAg.

In an example, a size of the first contact piece is different to a size of the second contact piece.

In an example, a diameter of the first contact piece is less than a diameter of the second contact piece.

According to an example, an upper lid 30 of the vacuum interrupter comprises a hole with a diameter greater than a diameter of the first contact piece and greater than a diameter of at least a portion of the first contact carrier adjacent to the first contact piece. The method then comprise inserting the first contact piece and the at least portion of the first contact carrier through the hole and fixedly connecting the first contact carrier to the upper lid.

In developing the new vacuum interrupter 1, it was determined that the advantages of different materials are appreciable. It was determined that CuCr contacts can be used for circuit breaker vacuum interrupters, representing a good compromise for low ohmic resistance, relatively low chopping current, good short-circuit switching performance, medium tendency to contact welding, low wear and reasonable production costs. They also determined that WCu contacts can be used for load break switches, representing a good compromise for low ohmic resistance, relatively low chopping current, good short-circuit switching performance as long as the current is below a certain limit, low tendency to contact welding, low wear and reasonable production costs. It was also determined that WCAg contacts can be used for contactors for its very low chopping current, its low tendency for the generation of surge voltages and its low tendency to contact welding; however, it has limitations in interrupting high short-circuit currents and it has relatively high costs.

By using contacts of different materials and/or different shapes, this provides for an overall increase in performance.

The following relates to specific embodiments of the vacuum interrupter, where reference is again made to FIGS. 1-3.

FIG. 1 shows a representation of a vacuum interrupter 1. It mainly consists of a fixed contact carrier 10, generally made of copper, a fixed or first contact piece 11, a movable contact carrier 20, generally made of copper, a movable or second contact piece 21, an upper lid 30, for example made of stainless steel, an insulator 40, for example made of ceramic or ceramics, a lower lid 50, for example made of stainless steel and a bellows 60, for example made of stainless steel.

The contact piece materials can comprise W, CuCr, CuBi, WCu, MoCu, WCAg with different material shares, e.g. CuCr25, CuCr35, CuCr50 and made via different production methods, like sintering from a powder containing all components or first sintering the component with the high resistance against wear and welding—like Cr, W or WC—and then infiltrating it with the component that has a low ohmic resistance—like Cu or Ag.

The contact pieces can also be CuCr alloyed with additives like oxides, nitrides or borides of Fe, Al, Cr, V, Nb, Ta, Hf, Sn, Zr or Si with a relative content of about 0.1% to 5% acting as dispersoids for increasing the hardness and the welding resistance are being considered.

As detailed above for the new vacuum interrupter, the fixed contact piece 11 and the movable contact piece 21 are made from different materials. However, the inventors established that specific advantages of different materials could be enabled by using the two contact pieces made from these different contact piece materials in one vacuum interrupter. In this way they found combinations where the specific advantages of each material can be combined.

In an advantageous embodiment, the material of the first contact piece is CuCr10, while the material of the second contact piece is CuCr50. Here, a vacuum interrupter is provided that has a higher short circuit switching performance and a higher welding resistance than a vacuum interrupter with two contacts made from CuCr10 and at the same time having a vacuum interrupter with a lower ohmic resistance than a vacuum interrupter with two contacts made from CuCr50.

The same approach can be used for other combinations with common variants of CuCr such as CuCr25 and CuCr35, and that the same approach can be used for combinations of WCAg such as WCAg40 and WCAg20.

In an advantageous embodiment, the material of the first contact piece is CuCr, while the material of the second contact piece is CuCr with a content of about 1% of additives acting as dispersoids to increase the hardness and welding resistance of the contact piece. Here vacuum interrupter is provided that has a higher short circuit switching performance and welding resistance than a vacuum interrupter with two contacts made from CuCr and at the same time having a vacuum interrupter with lower costs compared to a vacuum interrupter with two contact pieces made from CuCr with an additive.

In an advantageous embodiment, the material of the first contact piece is CuCr, while the material of the second contact piece is WCu or MoCu. Here the short circuit switching performance is extended to higher currents compared to a vacuum interrupter with two contacts made from WCu or MoCu and at the same time having a vacuum interrupter with a higher welding resistance and a lower chopping current compared to a vacuum interrupter with two contacts made of CuCr.

A combination of certain contact piece materials can however also result in unwanted results. For example, the combination of Cu in one contact piece with Ag in the other contact piece can result in easily welded contacts because of the property of Cu and Ag to establish a eutectic mixture. These combinations are therefore to be avoided.

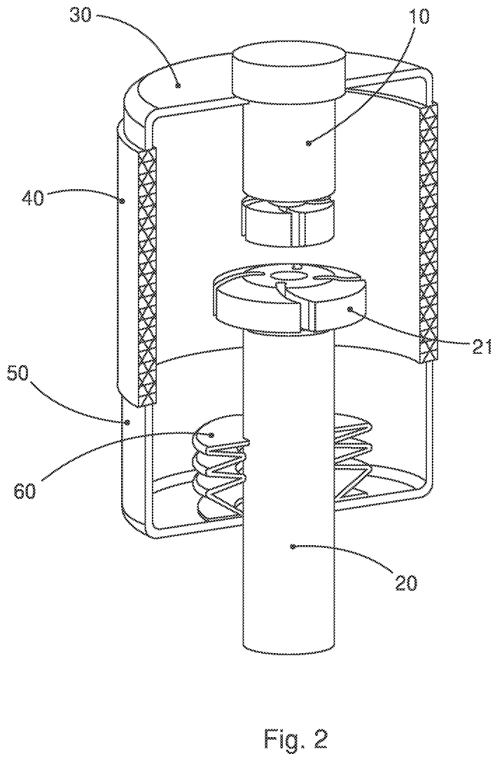

FIG. 2 shows an advantageous embodiment where one contact piece, here the fixed contact piece, has a different size than the other contact piece, beside of that the two contact pieces consist of different contact piece materials. When the contacts have different sizes and/or different shapes, they can have the same material. However, further advantages are provided when the materials of the contacts are different.

As the smaller contact piece consists of a lower amount of contact piece material, an advantage of this embodiment is a reduction of the production costs. Another advantage of the embodiment shown in FIG. 2 is that the diameter of the contact piece is not larger than the corresponding diameter in the upper lid 30, i.e., the fixed contact carrier 10 and the fixed contact piece 11 can be pre-assembled and then inserted as one piece into the upper lid before an OSB (one shot brazing) process. This simplifies the production process and reduces the risk that the contact piece 11 is misaligned or even falls off during the OSB process.

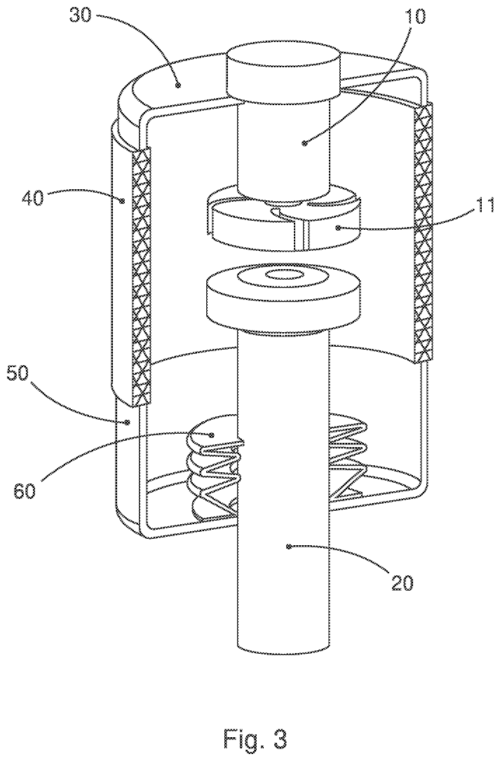

FIG. 3 shows an advantageous embodiment where the two contact pieces have different shapes beside of that the two contact pieces consist of different contact piece materials; again, as detailed above, the contacts can be of the same material when they have different shapes, but further advantages are provided when the materials are different. Especially for lower short-circuit interruption ratings, it is sufficient to install means for the generation of a magnetic field in one of the two contacts. The advantage is a reduction of the production costs.

Thus, the new vacuum interrupter uses two contact pieces of different contact piece materials in one vacuum interrupter with the target that the specific advantages of each material can be combined in one vacuum interrupter and that better compromises for the overall performance of a vacuum interrupter can be achieved.

### THE FOLLOWING REFERENCE NUMERALS APPLY

1 vacuum interrupter (VI)
10 Fixed contact carrier
11 Fixed or first contact piece
20 Movable contact carrier
21 Movable or second contact piece
30 Upper lid
40 Insulator
50 Lower lid
60 Bellows

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In an example, the first contact carrier is a fixed contact carrier, and the second contact carrier is a movable contact carrier. In the activated state the vacuum interrupter is configured to move the second contact carrier to bring the first contact piece and the second contact piece into contact with one another.

In an example, the material of the first contact piece is a first alloy of CuCr and the material of the second contact piece is a second alloy of CuCr.

In an example, the material of the first contact piece is CuCr10 and the material of the second contact piece is CuCr50.

In an example, the material of the first contact piece is CuCr25 and the material of the second contact piece is CuCr35.

In an example, the material of the first contact piece is a first alloy of WCAg and the material of the second contact piece is a second alloy of WCAg.

In an example, the material of the first contact piece is WCAg40 and the material of the second contact piece is WCAg20.

In an example, the material of the first contact piece is CuCr and the material of the second contact piece is CuCr with a content of 0.1% to 5% of at least one material comprising Fe, Al, Cr, V, Nb, Ta, Hf, Sn, Zr or Si.

In an example, the at least one material comprises an oxide, nitride or boride of Fe, Al, Cr, V, Nb, Ta, Hf, Sn, Zr or Si.

In an example, the material of the first contact piece is CuCr and the material of the second contact piece is WCu or MoCu.

In an example, the material of the first contact piece comprises one of W, CuCr, CuBi, WCu, MoCu, WCAg and the material of the second contact piece comprises one of W, CuCr, CuBi, WCu, MoCu, WCAg.

In an example, a size of the first contact piece is different to a size of the second contact piece.

In an example, a diameter of the first contact piece is less than a diameter of the second contact piece.

In an example, the vacuum interrupter comprises an upper lid, and the first contact carrier is fixedly connected to the upper lid. Prior to the first contact carrier being fixedly connected to the upper lid the upper lid comprises a hole with a diameter greater than a diameter of the first contact piece and greater than a diameter of at least a portion of the first contact carrier adjacent to the first contact piece.

In a second aspect, there is provided a method of manufacturing a vacuum interrupter, comprising: connecting a first contact piece to a first contact carrier; connecting a second contact piece to a second contact carrier; wherein a shape of the first contact piece is different to a shape of the second contact piece and/or a material of the first contact piece is different to a material of the second contact piece; wherein in a deactivated state the vacuum interrupter is configured to hold the first contact piece spaced from the second contact piece; and wherein in an activated state the vacuum interrupter is configured to bring the first contact piece and the second contact piece into contact with one another.

In an example, an upper lid comprises a hole with a diameter greater than a diameter of the first contact piece and greater than a diameter of at least a portion of the first contact carrier adjacent to the first contact piece, and wherein method comprises inserting the first contact piece and the at least portion of the first contact carrier through the hole and fixedly connecting the first contact carrier to the upper lid.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A vacuum interrupter, comprising:
a first contact carrier;
a first contact piece;
a second contact carrier; and
a second contact piece;
wherein the first contact piece is connected to the first contact carrier;
wherein the second contact piece is connected to the second contact carrier;
wherein a shape of the first contact piece is different to a shape of the second contact piece and/or a material of the first contact piece is different to a material of the second contact piece;
wherein in a deactivated state the vacuum interrupter is configured to hold the first contact piece spaced from the second contact piece; and
wherein in an activated state the vacuum interrupter is configured to bring the first contact piece and the second contact piece into contact with one another.

2. The vacuum interrupter according to claim 1, wherein the first contact carrier is a fixed contact carrier, and the second contact carrier is a movable contact carrier, and wherein in the activated state the vacuum interrupter is configured to move the second contact carrier to bring the first contact piece and the second contact piece into contact with one another.

3. The vacuum interrupter according to claim 1, wherein the material of the first contact piece is a first alloy of CuCr and the material of the second contact piece is a second alloy of CuCr.

4. The vacuum interrupter according to claim 1, wherein the material of the first contact piece is CuCr10 and the material of the second contact piece is CuCr50; or wherein the material of the first contact piece is CuCr25 and the material of the second contact piece is CuCr35.

5. The vacuum interrupter according to claim 1, wherein the material of the first contact piece is a first alloy of WCAg and the material of the second contact piece is a second alloy of WCAg.

6. The vacuum interrupter according to claim 1, wherein the material of the first contact piece is WCAg40 and the material of the second contact piece is WCAg20.

7. The vacuum interrupter according to claim 1, wherein the material of the first contact piece is CuCr and the material of the second contact piece is CuCr with a content of 0.1% to 5% of at least one material comprising Fe, Al, Cr, V, Nb, Ta, Hf, Sn, Zr or Si.

8. The vacuum interrupter according to claim 7, wherein the at least one material comprises an oxide, nitride or boride of Fe, Al, Cr, V, Nb, Ta, Hf, Sn, Zr or Si.

9. The vacuum interrupter according to claim 1, wherein the material of the first contact piece is CuCr and the material of the second contact piece is WCu or MoCu.

10. The vacuum interrupter according to claim 1, wherein the material of the first contact piece comprises one of W, CuCr, CuBi, WCu, MoCu, WCAg and the material of the second contact piece comprises one of W, CuCr, CuBi, WCu, MoCu, WCAg.

11. The vacuum interrupter according to claim 1, wherein a size of the first contact piece is different to a size of the second contact piece.

12. The vacuum interrupter according to claim 11, wherein a diameter of the first contact piece is less than a diameter of the second contact piece.

13. The vacuum interrupter according to claim 11, wherein the vacuum interrupter comprises an upper lid, wherein the first contact carrier is fixedly connected to the upper lid, wherein prior to the first contact carrier being fixedly connected to the upper lid the upper lid comprises a hole with a diameter greater than a diameter of the first contact piece and greater than a diameter of at least a portion of the first contact carrier adjacent to the first contact piece.

14. A method of manufacturing a vacuum interrupter, comprising:
connecting a first contact piece to a first contact carrier;
connecting a second contact piece to a second contact carrier;
wherein a shape of the first contact piece is different to a shape of the second contact piece and/or a material of the first contact piece is different to a material of the second contact piece;
wherein in a deactivated state the vacuum interrupter is configured to hold the first contact piece spaced from the second contact piece; and
wherein in an activated state the vacuum interrupter is configured to bring the first contact piece and the second contact piece into contact with one another.

15. The method according to claim 14, further comprising providing an upper lid having a hole with a diameter greater than a diameter of the first contact piece and greater than a diameter of at least a portion of the first contact carrier adjacent to the first contact piece, and wherein the method comprises inserting the first contact piece and the at least portion of the first contact carrier through the hole and fixedly connecting the first contact carrier to the upper lid.
